(19) United States
(12) Patent Application Publication
(10) Pub. No.: US 2018/0006321 A1
(43) Pub. Date: Jan. 4, 2018

(54) APPARATUS AND METHOD FOR SUPPLYING COMPONENT OF FUEL CELL STACK

(71) Applicants: HYUNDAI MOTOR COMPANY, Seoul (KR); KIA MOTORS CORPORATION, Seoul (KR)

(72) Inventors: Sang Hyun CHO, Hwaseong-si (KR); Nam Gu LEE, Yongin-si (KR)

(21) Appl. No.: 15/251,499

(22) Filed: Aug. 30, 2016

(30) Foreign Application Priority Data
Jul. 1, 2016 (KR) 10-2016-0083650

(51) Int. Cl. H01M 8/2404

(52) U.S. Cl. CPC H01M 8/2404

(57) ABSTRACT

An apparatus for supplying a component of a fuel cell stack includes a cartridge in which a plurality of components is stacked, a gripper for vacuum-adsorbing an uppermost component among the plurality of components stacked in the cartridge, and a lift generating unit for generating a lift force to lift only the uppermost component among the plurality of components, wherein the lift generating unit includes a plurality of air jet holes disposed symmetrically in a lower portion of the gripper and causes air to be blown toward an upper surface of the uppermost component.

### CROSS-REFERENCE TO RELATED APPLICATION

This application claims the benefit of priority to Korean Patent Application No. 10-2016-0083650, filed on Jul. 1, 2016 with the Korean Intellectual Property Office, the disclosure of which is incorporated herein in its entirety by reference.

### TECHNICAL FIELD

The present disclosure relates to an apparatus and a method for supplying a component of a fuel cell stack, such as a membrane electrode assembly (MEA) or a gas diffusion layer (GDL), stably when the fuel cell stack is manufactured.

### BACKGROUND

A fuel cell is a device that generates electrical energy through an electrochemical reaction of a fuel with an oxidizing agent.

The fuel cell may include a fuel cell stack, and the fuel cell stack may have a plurality of unit cells connected in series.

The unit cell of the fuel cell stack may include two bipolar plates allowing reactant gases to flow therein, a membrane electrode assembly (MEA) making an electrochemical reaction between the two bipolar plates, gas diffusion layers (GDLs) adjusting the flow of the gases between the bipolar plates and the MEA and gaskets for sealing.

The MEA may have a proton exchange membrane (PEM) and two electrode layers disposed on both surfaces of the PEM.

The GDL may serve to uniformly distribute the reactant gases to the MEA, remove reaction produced water and water vapor and provide electrical conduction through electron transfer.

The fuel cell stack has usually been manufactured by individually transferring the MEA and the GDLs and combining the MEA and the GDLs by assembly equipment. A component of the fuel cell stack, such as MEA or GDL, has usually been adsorbed sheet-by-sheet by a vacuum adsorption gripper to be supplied.

Meanwhile, the GDL may have a curve, a channel, and the like on the surface thereof and may be formed of a porous material.

While the GDL is being vacuum-adsorbed by the vacuum adsorption gripper, the GDLs stacked in a cartridge may not be adsorbed sheet-by-sheet, but two or more GDLs may be adsorbed together. Accordingly, a defect rate of fuel cell stacks may be increased, which may decrease productivity.

### SUMMARY

The present disclosure has been made to solve the above-mentioned problems occurring in the prior art while advantages achieved by the prior art are maintained intact.

An aspect of the present disclosure provides an apparatus and a method for supplying a component of a fuel cell stack that may minimize a defect rate of fuel cell stacks to increase productivity thereof, by vacuum-adsorbing a component, such as a membrane electrode assembly (MEA) or a gas diffusion layer (GDL), sheet-by-sheet, when the component of the fuel cell stack is vacuum-adsorbed to be supplied to fuel cell stack assembly equipment.

According to an aspect of the present disclosure, an apparatus for supplying a component of a fuel cell stack may include: a cartridge in which a plurality of components are stacked; a gripper for vacuum-adsorbing an uppermost component among the plurality of components stacked in the cartridge; and a lift generating unit for generating a lift force to lift only the uppermost component among the plurality of components, wherein the lift generating unit includes a plurality of air jet holes disposed symmetrically in a lower portion of the gripper and causes air to be blown toward an upper surface of the uppermost component.

The gripper may include a gripper body, and a plurality of adsorption holes may be formed in a lower surface of the gripper body.

The plurality of air jet holes may be symmetrically disposed in the lower surface of the gripper body.

The plurality of air jet holes may be symmetrically disposed to be adjacent to corners of the gripper body.

The air jet holes may form an eddy air flow when the air is blown.

The air jet holes may have a hole cup structure in the lower surface of the gripper body.

The air jet holes may have a sidewall to form a space for inducing an eddy air flow.

The cartridge may include a support plate which is movable upwardly and downwardly, and a driving unit which moves the support plate upwardly and downwardly.

A plurality of guides may be symmetrically disposed on a circumference of the support plate.

The plurality of guides may be provided with one or more position sensors for detecting a position of the component.

According to another aspect of the present disclosure, a method for supplying a component of a fuel cell stack includes: stacking a plurality of components on a support plate of a cartridge in a vertical direction and moving a gripper downwardly to adjust a gap between an uppermost component and the gripper; performing an air blow through air jet holes of a lift generating unit while performing vacuum-adsorption by adsorption holes of the gripper; and stopping the air blow when the uppermost component is adsorbed by the adsorption holes of the gripper after the air blow and the vacuum-adsorption.

An air injection pressure may be increased by a predetermined increasing amount unless the uppermost component is adsorbed by the adsorption holes of the gripper after the air blow and the vacuum-adsorption.

### BRIEF DESCRIPTION OF THE DRAWINGS

The above and other objects, features and advantages of the present disclosure will be more apparent from the following detailed description taken in conjunction with the accompanying drawings:

FIG. 1 illustrates a perspective view of an apparatus for supplying a component of a fuel cell stack, according to exemplary embodiments of the present disclosure;

FIG. 2 illustrates a front view of the apparatus for supplying a component of a fuel cell stack, illustrated in FIG. 1;

FIG. 3 illustrates a side view of the apparatus for supplying a component of a fuel cell stack, illustrated in FIG. 1;

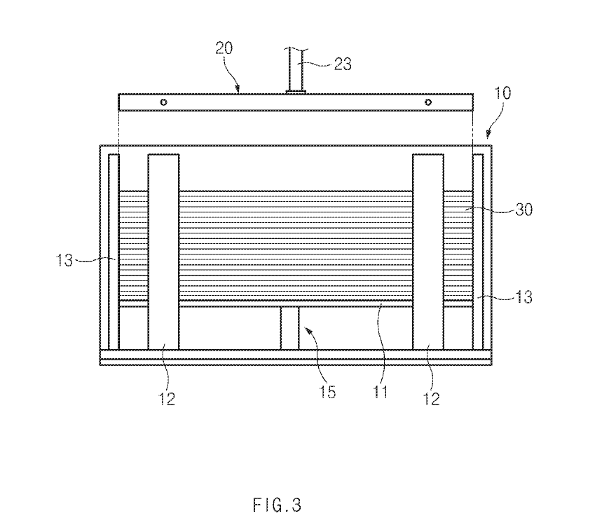

FIG. 4 illustrates a bottom perspective view of a gripper in an apparatus for supplying a component of a fuel cell stack, according to exemplary embodiments of the present disclosure;

FIG. 5 illustrates a cross-sectional view, taken along line A-A of FIG. 4;

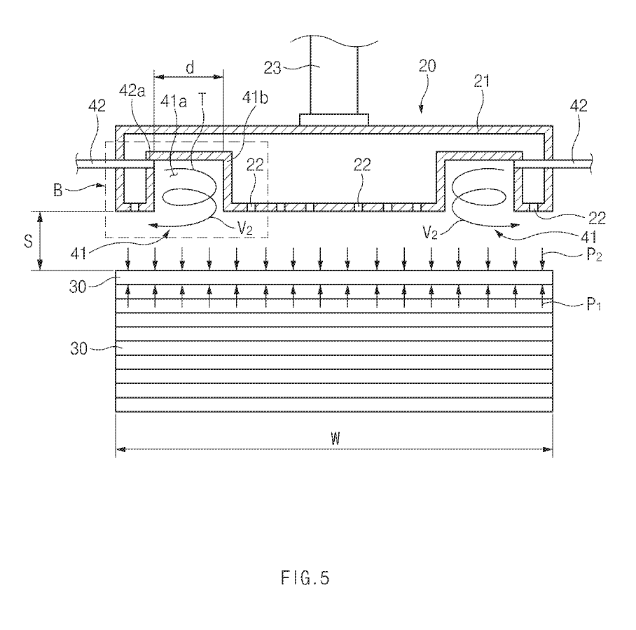

FIG. 6 illustrates an enlarged view of a portion indicated by arrow B of FIG. 5;

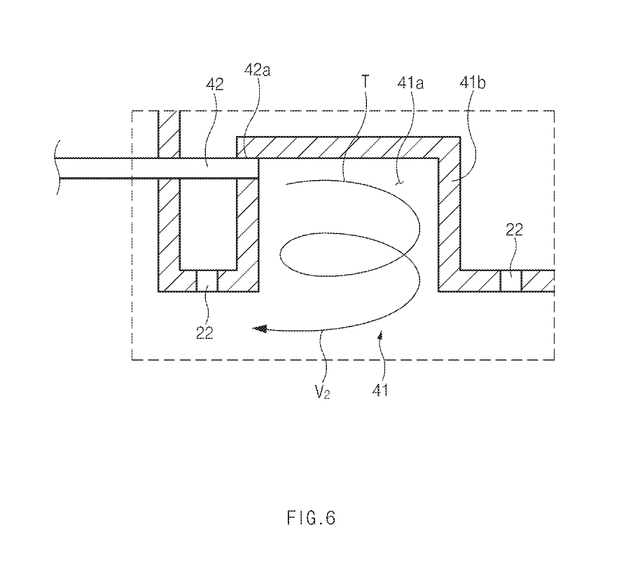

FIG. 7 illustrates operations of an apparatus for supplying a component of a fuel cell stack, according to exemplary embodiments of the present disclosure; and

FIG. 8 illustrates a flowchart of a method for supplying a component of a fuel cell stack, according to exemplary embodiments of the present disclosure.

### DETAILED DESCRIPTION

Hereinafter, exemplary embodiments of the present disclosure will be described in detail with reference to the accompanying drawings. For reference, the dimensions of elements, thicknesses of lines, and the like, illustrated in the drawings referred to in the description of exemplary embodiments of the present disclosure, may be exaggerated for convenience of understanding. In addition, terms used for describing the present inventive concept have been defined in consideration of the functions of elements, and may be altered in accordance with the intention of a user or an operator, in view of practice, or the like. Therefore, the terms should be defined on the basis of the entirety of this specification.

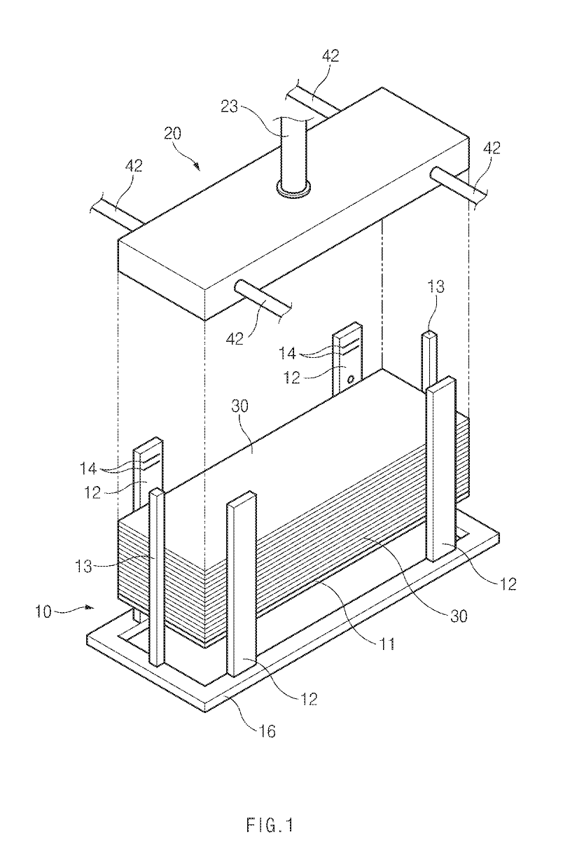

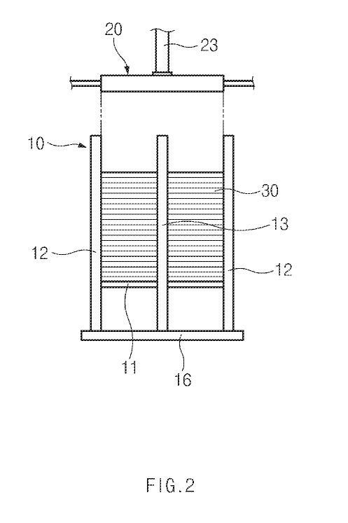

Referring to FIGS. 1 and 2, an apparatus for supplying a component of a fuel cell stack, according to exemplary embodiments of the present disclosure, may include a cartridge 10 in which a plurality of components 30 are stacked, and a gripper 20 that vacuum-adsorbs the components 30 stacked in the cartridge 10 sheet-by-sheet.

The cartridge 10 may be configured to support the plurality of components 30 stacked in a vertical direction, wherein the components 30 may be various elements constituting a unit cell of a fuel cell stack, such as a membrane electrode assembly (MEA) and a gas diffusion layer (GDL). For example, the component 30 may be a gas diffusion layer (GDL).

The cartridge 10 may include the support plate 11 which is movable upwardly and downwardly, and a driving unit 15 which moves the support plate 11 upwardly and downwardly.

The support plate 11 may have a structure corresponding to the shape of the component 30, and the plurality of components 30 may be stacked on an upper surface of the support plate 11 in the vertical direction.

A base 16 may be disposed below the support plate 11, and the support plate 11 may be provided to be movable with respect to the base 16 upwardly and downwardly.

A plurality of guides 12 and 13 may be disposed on the circumference of the support plate 11. The plurality of guides 12 and 13 may include a plurality of first guides 12 disposed to be symmetrical to each other on left and right sides of the support plate 11, and a plurality of second guides 13 disposed to be symmetrical to each other on front and rear sides of the support plate 11. The plurality of first and second guides 12 and 13 may be extended upwardly from the base 16. The guides 12 and 13 may have a bar shape of which a surface adjacent to the components 30 has a predetermined area such that the surface adjacent to the components 30 is in surface contact with portions of the components 30. Thus, if the components 30 are the gas diffusion layers, the guides 12 and 13 may stably surface-contact with the brittle gas diffusion layers to effectively prevent damage to the gas diffusion layers.

The driving unit 15 may be configured to move the support plate 11 upwardly and downwardly. For example, the driving unit 15 includes a driving motor, a feed screw and the like. The driving unit 15 may move the support plate 11 upwardly and downwardly to adjust the height of the support plate 11, such that a gap between an upper surface of an uppermost component 30 and the gripper 20 may be constantly maintained.

One or more position sensors 14 may be provided on the plurality of guides 12 and 13 to detect the position of the component 30. The position sensor 14 may detect the position of the uppermost components 30 among the plurality of components 30. As the position sensor 14 detects the position of the uppermost component 30 in real time, the driving unit 15 may adjust the upward and downward movements of the support plate 11 such that a gap S between the upper surface of the uppermost component 30 and the gripper 20 may be constantly maintained regardless of the number of the components 30.

For example, two position sensors 14 may be spaced apart from each other in the vertical direction so as to more precisely measure the position of the uppermost component 30.

The gripper 20 may include a gripper body 21, and a plurality of adsorption holes 22 may be formed in a lower surface of the gripper body 21.

A connector 23 may be provided on an upper surface of the gripper body 21 to be connected to an arm of a transfer robot. The gripper body 21 may be moved in a vertical direction and a horizontal direction through the operation of the transfer robot. With respect to the operation of the gripper body 21, after the gripper body 21 is moved downwardly by the transfer robot to be close to the components 30 in the cartridge 10, the components 30 stacked in the cartridge 10 may be vacuum-adsorbed sheet-by-sheet. After the gripper body 21 to which the uppermost component 30 has been adsorbed is moved upwardly by the transfer robot, the gripper body 21 may be moved in the horizontal direction to a particular position of fuel cell stack assembly equipment (not shown).

A vacuum generating source (not shown) such as a vacuum pump and a vacuum ejector may be connected to the plurality of adsorption holes 22. When vacuum suction force is generated by the operation of the vacuum generating source, the uppermost component 30 among the plurality of components 30 stacked in the cartridge 10 may be vacuum-adsorbed to the lower surface of the gripper body 21 through the adsorption holes 22.

According to exemplary embodiments of the present disclosure, a lift generating unit 40 may generate a lift force that lifts only the uppermost component 30 upwardly.

In particular, the lift generating unit 40 may generate the lift force adequate to separate the uppermost component 30 from the components 30 disposed therebelow and lift only the uppermost component 30 upwardly.

The lift generating unit 40 may include a plurality of air jet holes 41 formed in the lower surface of the gripper body 21, and air supply hoses 42 supplying air to the plurality of air jet holes 41.

The plurality of air jet holes 41 may cause the air to be blown to a space between the lower surface of the gripper body 21 and the upper surface of the uppermost component 30 at a constant rate V₂. In particular, the air may be blown by the air jet holes 41 downwardly from the lower surface of the gripper body 21 to the upper surface of the uppermost component 30.

The air jet holes 41 may have a uniform diameter d. For example, the diameter d of the air jet hole 41 may be greater than or equal to ¼ of a width W of the component 30 (d≧W×¼). When the diameter d of the air jet hole 41 is less than or equal to ¼ of the width W of the component 30, the lift force of the lift generating unit 40 may be reduced, whereby the component 30 may not be smoothly lifted.

The air supply hoses 42 may penetrate through sidewalls of the gripper body 21 to be individually connected to the plurality of air jet holes 41. A solenoid valve (not shown) may be provided in the middle of the air supply hose 42 to control the opening thereof, thereby appropriately adjusting an air injection pressure depending on the weight of the component 30.

When Beroulli's equation is applied to the air flow state of the uppermost component 30 in a state in which the air is blown to the upper surface of the uppermost component 30 by the plurality of air jet holes 41 at a constant rate V₂, a pressure difference between the upper and lower surfaces of the uppermost component 30 may be expressed by the following equation 1:

ΔP=P₂−P₁=½ρ₂V₂²−½ρ₁V₁²=½ρ₂V₂² [Equation 1]

Here, ρ is air density, P₂ is static pressure applied to the upper surface of the uppermost component 30, V₂ is an injection rate of air flowing on the upper surface of the uppermost component 30, and P₁ is static pressure applied to the lower surface of the uppermost component 30. Since the other components 30 are stacked below the lower surface of the uppermost component 30, there is no air flow, and thus V₁=0.

According to [Equation 1], the pressure difference ΔP of the uppermost component 30 may depend on the injection rate V₂ of air blown to the upper surface of the component 30, and the uppermost component 30 may receive a lift force F_{lift} expressed by the following equation 2:

F_{LIFT}=C_{L}½ρ₂V₂²A [EQUATION 2]

Here, ρ is air density, A is a cross-sectional area of the component 30, and C_{L} is a lift coefficient.

As the injection rate V₂ of air blown to the upper surface of the uppermost component 30 is increased, the lift force F_{lift} may be increased. In particular, when the lift force F_{lift} is greater than the weight of the uppermost component 30, the uppermost component 30 may be separated from the components stacked therebelow and be lifted upwardly.

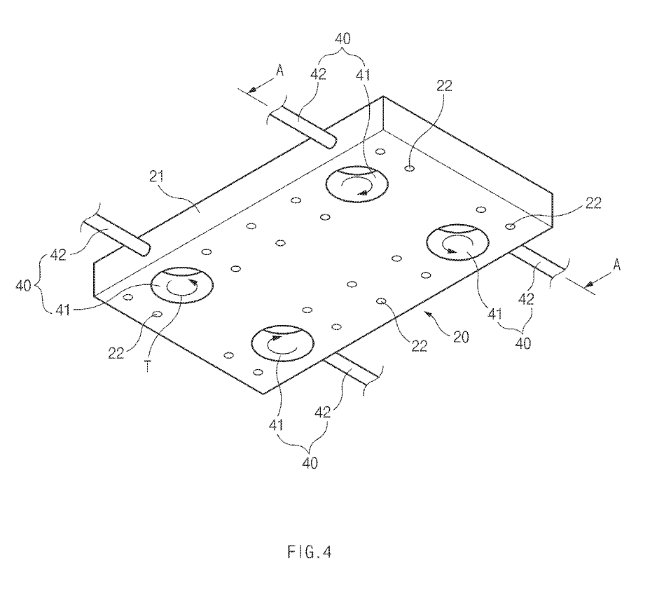

According to exemplary embodiments of the present disclosure, as illustrated in FIG. 4, the air jet hole 41 may be provided to have a hole cup structure in the lower surface of gripper body 21, and a supply end portion 42a of the air supply hose 42 may be provided to penetrate through a side surface of the air jet hole 41 in a horizontal direction.

The air jet hole 41 may have a sidewall 41b of a ring shape to form a space 41a for inducing an eddy flow (spiral flow) of air. The supply end portion 42a of the air supply hose 42 may be provided to penetrate through the sidewall 41b of the air jet hole 41 in the horizontal direction. The air supplied through the end portion 42a of the air supply hose 42 may flow along the sidewall 41b of the air jet hole 41 to be blown while the eddy air flow is being formed in the air jet hole 41.

According to other exemplary embodiments of the present disclosure, a spiral groove (not shown) may be formed in the internal surface of the sidewall 41b of the air jet hole 41. Accordingly, the air supplied through the supply end portion 42a of the air supply hose 42 may be blown by the air jet hole 41 while forming the eddy flow (spiral flow) along the spiral groove of the air jet hole 41 with more stability.

As stated above, the plurality of air jet holes 41 may cause the air to be blown to the upper surface of the uppermost component 30 symmetrically while forming the eddy air flow, such that the air blow direction may not be inclined toward any one direction. When the uppermost component 30 is lifted upwardly by the lift force, the inclination of the uppermost component 30 toward any one direction may be effectively prevented.

According to exemplary embodiments of the present disclosure, the plurality of air jet holes 41 may be disposed to be symmetrical to each other in the front and rear directions and the left and right directions in the lower surface of the gripper body 21, and thus, the air may be symmetrically blown to the upper surface of the uppermost component 30.

In particular, the plurality of air jet holes 41 may be arranged to be adjacent to respective corners of the gripper body 21, and thus, a symmetrical arrangement of the air jet holes 41 may be effectively implemented.

In this manner, the air blow direction may be symmetrically formed by the plurality of air jet holes 41 symmetrically arranged in the lower surface of the gripper body 21, without being inclined toward any one direction. Accordingly, a drag force may not be generated in any particular direction when the uppermost component 30 lifts upwardly, and thus, the components 30 may stably be arranged in the vertical direction, and when each of the components 30 is adsorbed by the gripper body 21, the uppermost component 30 may be positioned at the same position.

Meanwhile, the gap S between the upper surface of the uppermost component 30 and the gripper 20 may be adjusted to allow the gripper 20 to facilitate an easier adsorption of the uppermost component 30. For example, the gap S may be approximately 2-15 mm. When the gap S is less than or equal to 2 mm, the influence of the drag force may be excessive. When the gap S is greater than or equal to 15 mm, the lift force may be insufficient to lift the component 30.

According to exemplary embodiments of the present disclosure, when the plurality of components 30 are stacked in the cartridge 10 and the air is blown through the air jet holes 41 of the lift generating unit 40 at the constant rate V₂, the lift force may be generated to lift the uppermost component 30 among the plurality of components 30 upwardly according to Beroulli's principle, and thus, the uppermost component 30 may be separated from the components 30 disposed therebelow and be lifted upwardly.

If only the uppermost component 30 is separated and lifted in the above-described manner, only one component disposed in the uppermost position may be adsorbed by the adsorption holes 22 of the gripper 20. As described above, since a component disposed in the uppermost position among the plurality of stacked components 30 is adsorbed by the lift generating unit 40 sheet-by-sheet, a defect rate of fuel cell stacks may be minimized and a productivity thereof may be improved.

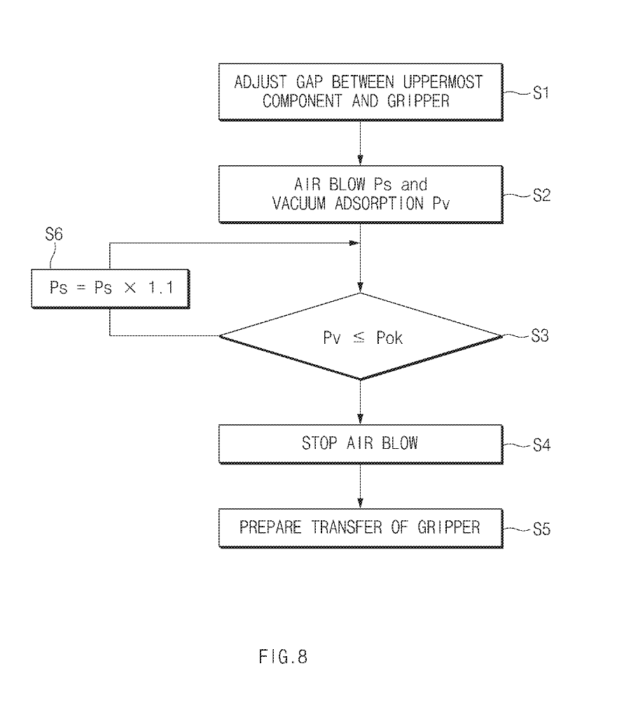

FIG. 8 illustrates a flowchart of a method for supplying a component of a fuel cell stack, according to exemplary embodiments of the present disclosure.

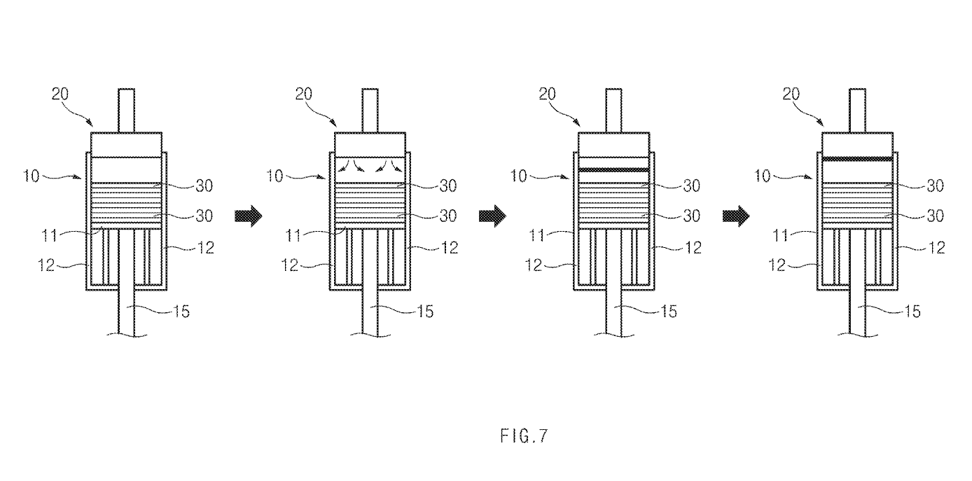

Referring to FIGS. 7 and 8, the plurality of components 30 may be stacked on the support plate 11 of the cartridge 10 in a vertical direction, and the support plate 11 may be lifted by the driving unit and the gripper body 21 of the gripper 20 may be lowered 15 to adjust the gap S between the uppermost component 30 and the gripper 20 in operation S1.

The air blow may be performed by the air jet holes 41 of the lift generating unit 40 and the vacuum adsorption may be performed by the adsorption holes 22 of the gripper 20 in operation S2. In detail, by supplying the air to the air jet holes 41 of the lift generating unit 40 through the air supply hose 42 at a predetermined air injection pressure Ps, the air may be blown to an upper surface of the uppermost component 30, while a constant vacuum pressure Pv may be applied to the adsorption holes 22 of the gripper 20. Here, an initial air injection pressure Ps may be a half of the maximum pressure Pmax for generating a lift force.

Then, it may be determined whether or not the uppermost component 30 is adsorbed by the adsorption holes 22 of the gripper 20 in operation S3. Here, when the vacuum pressure Pv is lower than or equal to a vacuum adsorption completion pressure Pok (Pv≦Pok), the component 30 may be adsorbed by the adsorption holes 22 of the gripper 20, and when the vacuum pressure Pv is higher than the vacuum adsorption completion pressure Pok (Pv>Pok), the component 30 may not be adsorbed by the adsorption holes 22 of the gripper 20.

After the uppermost component 30 is separated from the components 30 disposed therebelow and is lifted by the initial air injection pressure Ps, when the uppermost component 30 is adsorbed by the adsorption holes 22 of the gripper 20, the air blow by the air jet holes 41 may be stopped in operation S4. Thereafter, the transfer of the gripper 20 may be prepared by the transfer robot in operation S5.

When the uppermost component 30 is not adsorbed by the adsorption holes 22 of the gripper 20 in operation S4, the air injection pressure Ps may be increased by a predetermined increasing amount (Ps×1.1) in operation S6, and the determination in operation S3 as to whether the uppermost component 30 is adsorbed by the adsorption holes 22 of the gripper 20 may be repeatedly performed.

As set forth above, when the component of the fuel cell stack, such as MEA or GDL, is vacuum-adsorbed to be supplied to the fuel cell stack assembly equipment, the component may be vacuum-adsorbed sheet-by-sheet, whereby the defect rate of fuel cell stacks may be minimized and a productivity thereof may be improved.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for supplying a component of a fuel cell stack, the apparatus comprising:
a cartridge in which a plurality of components is stacked;
a gripper for vacuum-adsorbing an uppermost component among the plurality of components stacked in the cartridge; and
a lift generating unit for generating a lift force to lift only the uppermost component among the plurality of components,
wherein the lift generating unit includes a plurality of air jet holes disposed symmetrically in a lower portion of the gripper and causes air to be blown toward an upper surface of the uppermost component.

2. The apparatus according to claim 1, wherein the gripper includes a gripper body, and wherein a plurality of adsorption holes is formed in a lower surface of the gripper body.

3. The apparatus according to claim 2, wherein the plurality of air jet holes is symmetrically disposed in the lower surface of the gripper body.

4. The apparatus according to claim 2, wherein the plurality of air jet holes is symmetrically disposed to be adjacent to corners of the gripper body.

5. The apparatus according to claim 2, wherein the air jet holes form an eddy air flow when the air is blown.

6. The apparatus according to claim 2, wherein the air jet holes have a hole cup structure in the lower surface of the gripper body.

7. The apparatus according to claim 6, wherein the air jet holes have a sidewall to form a space for inducing an eddy air flow.

8. The apparatus according to claim 1, wherein the cartridge includes:
a support plate which is movable upwardly and downwardly; and
a driving unit which moves the support plate upwardly and downwardly.

9. The apparatus according to claim 8, wherein a plurality of guides is symmetrically disposed on a circumference of the support plate.

10. The apparatus according to claim 9, wherein the plurality of guides is provided with one or more position sensors detecting a position of the component.

11. A method for supplying a component of a fuel cell stack, the method comprising:
stacking a plurality of components on a support plate of a cartridge in a vertical direction and moving a gripper downwardly to adjust a gap between an uppermost component and the gripper;
performing an air blow through air jet holes of a lift generating unit while performing vacuum-adsorption by adsorption holes of the gripper; and
stopping the air blow when the uppermost component is adsorbed by the adsorption holes of the gripper after the air blow and the vacuum-adsorption.

12. The method according to claim 11, wherein an air injection pressure is increased by a predetermined increasing amount unless the uppermost component is adsorbed by the adsorption holes of the gripper after the air blow and the vacuum-adsorption.
